(19) United States
(12) Patent Application Publication
(10) Pub. No.: US 2022/0148196 A1
(43) Pub. Date: May 12, 2022

(54) IMAGE PROCESSING APPARATUS, IMAGE PROCESSING METHOD, AND STORAGE MEDIUM

(71) Applicant: CANON KABUSHIKI KAISHA, Tokyo (JP)

(72) Inventors: Hajime Muta, Kanagawa (JP); Kotaro Yano, Tokyo (JP)

(21) Appl. No.: 17/520,553

(22) Filed: Nov. 5, 2021

(30) Foreign Application Priority Data
Nov. 10, 2020 (JP) 2020-187239

(51) Int. Cl. G06T 7/20; G06N 20/00

(52) U.S. Cl. CPC G06T 7/20; G06N 20/00; G06T 2207/20084; G06T 2207/20081; G06T 2207/30196

(57) ABSTRACT

An image processing apparatus includes an input image acquisition unit configured to acquire, as an input image, time-series images obtained by capturing a plurality of objects, a map acquisition unit configured to acquire an interaction map that indicates a difference between a first motion of a first object and a second motion of a second object at respective positions of each of the plurality of objects in the input image, by using the input image, and a state detection unit configured to detect a state of the first motion present in the input image using the interaction map, wherein the interaction map is estimated based on a trained model for estimating the interaction map and a parameter set prepared in advance.

### BACKGROUND

### Technical Field

One disclosed aspect of the embodiments relates to an image processing technique for analyzing a captured image.

### Description of the Related Art

Japanese Patent Application Laid-Open No. 2012-022370 discusses a system that obtains an optical flow from an image to estimate a motion vector, and processes the estimation result of the motion vector to identify an unsteady state of a crowd, such as a backward move.

In these days, the following image processing apparatus is discussed. That is, based on an image captured by a video camera or a security camera (hereinafter, referred to as a “camera”), an image processing apparatus analyzes the density and the degree of congestion of persons in an image capturing region. For example, the effect of preventing an accident or a crime involved in congestion in a facility where many persons gather, an event venue, a park, or a theme park by analyzing the density and the degree of congestion of persons is expected. To prevent an accident or a crime, it is important to detect an unsteady state of a crowd that can cause the accident or the crime, i.e., an abnormal state of a crowd, with high accuracy based on an image captured by a camera.

Examples of an issue arising when a motion vector of a person is estimated include the stay of the person. A person who stays may not be in a completely still state, and may often be accompanied by a minute fluctuation such as the forward, backward, leftward, and rightward movements of the head or a change in the direction of the face. Accordingly, if an attempt is made to estimate the motion vector of the person who stays, the above minute fluctuation causes an instability such as momentary changes in the moving direction of the person even though the person stays. This significantly decreases the accuracy of estimation of the moving direction.

Other examples of an issue arising when a motion vector of a person is estimated include a case where at the moment when two moving persons approach each other, the estimation results of motion vectors of the persons indicate directions completely different from the normal moving directions of the persons. Consequently, at the moment when the persons approach each other, an incorrect estimation result that the persons switch each other or turn around without passing each other may occur. This significantly decreases the accuracy of estimation of the moving directions. As described above, the conventional technique has an issue that the accuracy of detection of an abnormal state such as a stay or a backward move decreases due to the influence of a decrease in the accuracy of estimation of a moving direction.

### SUMMARY

One disclosed aspect of the embodiments is directed to an image processing apparatus that enables the acquisition of an abnormal state of an object such as a person in an image with high accuracy.

According to an aspect of the embodiments, an image processing apparatus includes an input image acquisition unit, a map acquisition unit, and a state detection unit. The input image acquisition unit is configured to acquire, as an input image, time-series images obtained by capturing a plurality of objects. The map acquisition unit is configured to acquire an interaction map that indicates a difference between a first motion of a first object and a second motion of a second object at respective positions of each of the plurality of objects in the input image, by using the input image. The state detection unit is configured to detect a state of the first motion of the object present in the input image using the interaction map, wherein the interaction map is estimated based on a trained model for estimating the interaction map and a parameter set prepared in advance.

Further features of the disclosure will become apparent from the following description of exemplary embodiments with reference to the attached drawings.

### BRIEF DESCRIPTION OF THE DRAWINGS

FIG. 1 is a block diagram illustrating an example of a hardware configuration of an image processing apparatus.

FIG. 2A is a block diagram illustrating an example of a configuration of an image analysis system.

FIG. 2B is a block diagram illustrating an example of a functional configuration of the image analysis apparatus.

FIG. 2C is a block diagram illustrating an example of a functional configuration of a learning apparatus.

FIG. 3 is a flowchart illustrating an example of a flow of an image analysis process.

FIG. 4 is a diagram illustrating an example of a neural network.

FIG. 5A is a diagram illustrating an example of an input image.

FIG. 5B is a diagram illustrating an example of an estimation result.

FIG. 5C is a diagram illustrating an example of a portion where an abnormal state is identified.

FIG. 6A is a diagram illustrating an example of a display of an occurrence position of a crowd state, a warning display, and an interaction map.

FIG. 6B is a diagram illustrating an example of the display of the occurrence position of the crowd state, the warning display, and the interaction map.

FIG. 7 is a diagram illustrating another example of a neural network.

FIG. 8 is a flowchart illustrating an example of a flow of a learning process.

FIG. 9A is a diagram illustrating an example of a first property of an interaction.

FIG. 9B is a diagram illustrating an example of a second property of the interaction.

FIG. 9C is a diagram illustrating an example of a third property of the interaction.

FIG. 10A is a diagram illustrating an example of a fourth property of the interaction.

FIG. 10B is a diagram illustrating an example of the fourth property of the interaction.

FIG. 11A is a diagram illustrating an example in which a sum of values of interactions is calculated.

FIG. 11B is a diagram illustrating an example in which the sum of the values of the interactions is calculated.

FIG. 12A is a diagram illustrating an example of a method for obtaining a set of persons.

FIG. 12B is a diagram illustrating an example of the method for obtaining the set of persons.

FIG. 13A is a diagram illustrating examples of a training image and a method for creating an interaction supervised map.

FIG. 13B is a diagram illustrating examples of the training image and the method for creating the interaction supervised map.

FIG. 13C is a diagram illustrating examples of the training image and the method for creating the interaction supervised map.

FIG. 13D is a diagram illustrating examples of the training image and the method for creating the interaction supervised map.

### DESCRIPTION OF THE EMBODIMENTS

In response to the issues in the conventional techniques, an image processing apparatus according to the present exemplary embodiment estimates the motion of a person based on a trained model for estimating an interaction map from an image, thereby acquiring an abnormal state of an object such as a person in an image with high accuracy.

Based on the attached drawings, exemplary embodiments will be described in detail. The configurations illustrated in the following exemplary embodiments are merely examples, and the disclosure is not limited to the configurations illustrated in the drawings.

A first exemplary embodiment is described taking an example in which two temporally consecutive images of a moving image captured by an imaging apparatus such as a video camera or a security camera (hereinafter, referred to as a “camera”) are used as an input image, an interaction map estimation result is acquired, and a crowd state is detected and displayed.

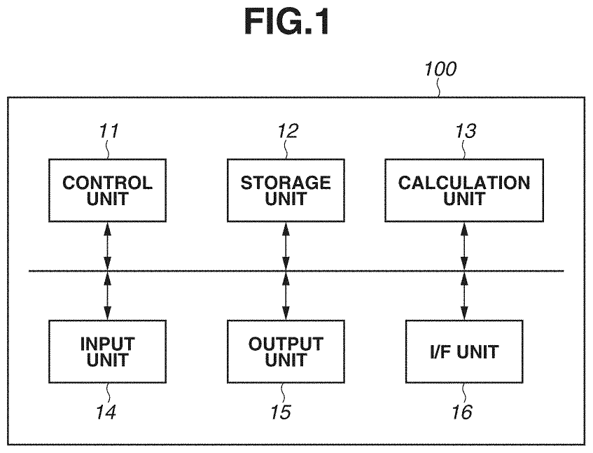

FIG. 1 is a block diagram illustrating an example of a hardware configuration of an image processing apparatus 100 according to the present exemplary embodiment.

The image processing apparatus 100 includes as hardware components a control unit 11, a storage unit 12, a calculation unit 13, an input unit 14, an output unit 15, an interface (I/F) unit 16, and a bus.

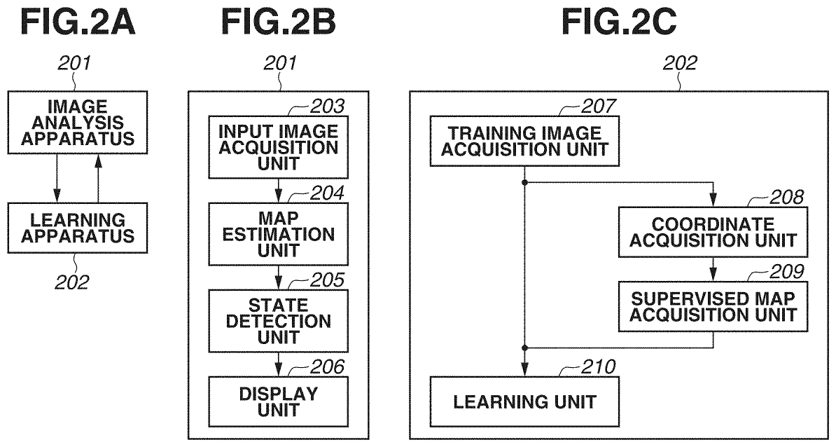

The control unit 11 controls the entire image processing apparatus 100. Based on control of the control unit 11, the calculation unit 13 reads and writes data from and to the storage unit 12 as needed and executes various calculation processes. For example, the control unit 11 and the calculation unit 13 are composed of a central processing unit (CPU), and the functions of the control unit 11 and the calculation unit 13 are achieved by, for example, the CPU reading a program from the storage unit 12 and executing the program. In other words, the CPU executes an image processing program according to the present exemplary embodiment, thereby achieving functions and processes related to the image processing apparatus 100 according to the present exemplary embodiment. Alternatively, the image processing apparatus 100 may include one or more pieces of dedicated hardware different from the CPU, and the pieces of dedicated hardware may execute at least a part of the processing of the CPU. Examples of the pieces of dedicated hardware include a graphics processing unit (GPU), an application-specific integrated circuit (ASIC), a field-programmable gate array (FPGA), and a digital signal processor (DSP). In the present exemplary embodiment, the CPU executes processing according to the program according to the present exemplary embodiment, thereby executing functions and processes of the image processing apparatus 100 illustrated in FIG. 2.

The storage unit 12 holds programs and data required for the control operation of the control unit 11 and the calculation processes of the calculation unit 13. The storage unit 12 includes a read-only memory (ROM), a random-access memory (RAM), a storage device such as a hard disk drive (HDD) or a solid-state drive (SSD), and a recording medium such as a flash memory. The HDD or the SSD stores the image processing program according to the present exemplary embodiment and data accumulated for a long period. For example, the ROM stores fixed programs and fixed parameters that do not need to be changed, such as a program for starting and ending the hardware apparatus and a program for controlling the basic input and output, and is accessed by the CPU when needed. The image processing program according to the present exemplary embodiment may be stored in the ROM. The RAM temporarily stores a program and data supplied from the ROM, the HDD, or the SSD and data supplied from outside via the I/F unit 16. The RAM temporarily saves a part of a program that is being executed, accompanying data, and the calculation result of the CPU.

The input unit 14 includes an operation device such as a human interface device and inputs an operation of a user to the image processing apparatus 100. The operation device of the input unit 14 includes a keyboard, a mouse, a joystick, and a touch panel. User operation information input from the input unit 14 is sent to the CPU via the bus. In response to an operation signal from the input unit 14, the control unit 11 gives an instruction to control a program that is being executed and control another component.

The output unit 15 includes a display such as a liquid crystal display or a light-emitting diode (LED) and a loudspeaker. The output unit 15 displays the processing result of the image processing apparatus 100, to present the processing result to the user. For example, the output unit 15 can also display the state of a program that is being executed or the output of the program to the user. For example, the output unit 15 displays a graphical user interface (GUI) for the user to operate the image processing apparatus 100.

Although FIG. 1 illustrates an example in which the input unit 14 and the output unit 15 are present inside the image processing apparatus 100, at least one of the operation device of the input unit 14 and the display of the output unit 15 may be present as another device outside the image processing apparatus 100.

The I/F unit 16 is a wired interface using Universal Serial Bus, Ethernet®, or an optical cable, or a wireless interface using Wi-Fi® or Bluetooth®. The I/F unit 16 has a function of connecting a camera to the image processing apparatus 100 and inputting a captured image to the image processing apparatus 100, a function of transmitting an image processing result obtained by the image processing apparatus 100 to outside, and a function of inputting a program and data required for the operation of the image processing apparatus 100 to the image processing apparatus 100.

FIGS. 2A to 2C are diagrams illustrating examples of functional configurations of an image analysis apparatus and a learning apparatus as the image processing apparatus according to the present exemplary embodiment.

FIG. 2A is a diagram illustrating an example of a configuration of an entire system including an image analysis apparatus 201 that performs an image analysis process and a learning apparatus 202 that performs a learning process in the image processing apparatus 100 according to the present exemplary embodiment.

In FIG. 2A, the image analysis apparatus 201 acquires image data as an analysis target and outputs an analysis result.

The learning apparatus 202 acquires, by learning, a parameter set to be used when the image analysis apparatus 201 performs an analysis process.

FIG. 2B is a diagram illustrating an example of a functional configuration of the image analysis apparatus 201.

In FIG. 2B, the image analysis apparatus 201 includes, as functional components, an input image acquisition unit 203, a map estimation unit 204, a state detection unit 205, and a display unit 206. The term “unit” may refer to a physical device or circuit, or a functionality that is performed by executing a program from the CPU in the image processing apparatus 100.

The input image acquisition unit 203 acquires, as an input image, time-series images obtained by capturing a plurality of objects (persons in the present exemplary embodiment) as a processing target for detecting a crowd state.

Using a parameter set acquired by the learning apparatus 202 performing learning in advance, the map estimation unit 204 acquires an interaction map that, at a position where each of the plurality of persons is present in the input image acquired by the input image acquisition unit 203, indicates the difference between the motion of the person and the motion of another person. Then, the map estimation unit 204 outputs the interaction map as an interaction map estimation result.

Using the interaction map estimation result output from the map estimation unit 204, the state detection unit 205 detects the state of the motion of the person present in the input image and detects a crowd state.

The display unit 206 displays or outputs the input image acquired by the input image acquisition unit 203, the interaction map estimation result output from the map estimation unit 204, or the crowd state detected by the state detection unit 205 via the output unit 15 or the I/F unit 16.

FIG. 2C is a diagram illustrating an example of a functional configuration of the learning apparatus 202.

The learning apparatus 202 includes as functional components a training image acquisition unit 207, a coordinate acquisition unit 208, a supervised map acquisition unit 209, and a learning unit 210.

The training image acquisition unit 207 acquires, as a training image, time-series images obtained by capturing a plurality of objects required for learning.

Using the training image acquired by the training image acquisition unit 207, the coordinate acquisition unit 208 acquires person coordinates in the training image.

Based on the person coordinates acquired by the coordinate acquisition unit 208, the supervised map acquisition unit 209 acquires an interaction supervised map where the value of an interaction indicating the difference between the motions of a certain person and other persons near the certain person is assigned.

The learning unit 210 learns a trained model to which the training image acquired by the training image acquisition unit 207 is input as input data and which outputs an interaction map of the training image from the training image using the interaction supervised map acquired by the supervised map acquisition unit 209 as supervised data. Then, the learning unit 210 outputs a parameter set for the image analysis apparatus 201 to perform an analysis process.

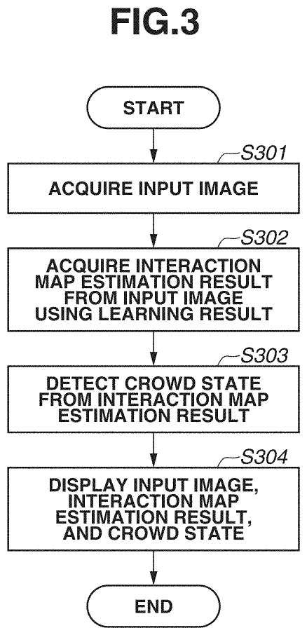

FIG. 3 is a flowchart illustrating an example of a flow of image processing (image analysis process) performed by the image analysis apparatus 201 according to the present exemplary embodiment.

First, in step S301, the input image acquisition unit 203 acquires, as an input image, time-series images obtained by capturing a plurality of persons as a processing target for detecting a crowd state. In the present exemplary embodiment, the input image is, for example, two temporally consecutive images obtained from a streaming file, a moving image file, a series of image files saved for each frame, or a moving image or images saved in a medium. For example, the two images may be images of a frame N and a frame N+k, where N is an integer and k is a natural number. Alternatively, the two images may be images at a time T and a time T+t, where T is arbitrary time and t is a value greater than 0.

The input image acquisition unit 203 may acquire, as the input image, a captured image from a solid-state image sensor, such as a complementary metal-oxide-semiconductor (CMOS) sensor or a charge-coupled device (CCD) sensor, or a camera on which a solid-state image sensor is mounted, or an image read from a storage device such as the HDD or the SSD or the recording medium.

Next, in step S302, using a parameter set obtained by the learning apparatus 202, the map estimation unit 204 estimates an interaction map for a plurality of objects (a plurality of persons) from the input image acquired by the input image acquisition unit 203, and acquires an interaction map estimation result. In the present exemplary embodiment, the interaction map is a map having a great value in a case where a certain person makes a motion different from that of other persons near the certain person, for example, at the position where a backward move, an interruption, or a standstill occurs. The details of the interaction map will be described below.

As a method for estimating the interaction map from the input image and outputting the interaction map estimation result, various known methods can be used. Examples of the method include a method of performing learning using machine learning or a neural network. Examples of the method using machine learning include bagging, bootstrapping, and random forests. Examples of the neural network include a convolutional neural network, a deconvolutional neural network, and an autoencoder obtained by linking both neural networks. Other examples of the neural network include a neural network having a shortcut such as U-Net. The neural network having a shortcut such as U-Net is discussed in O. Ronneberger, etc. (2015) (O. Ronneberger, P. Fischer, T. Brox, arXiv:1505.04597 (2015)).

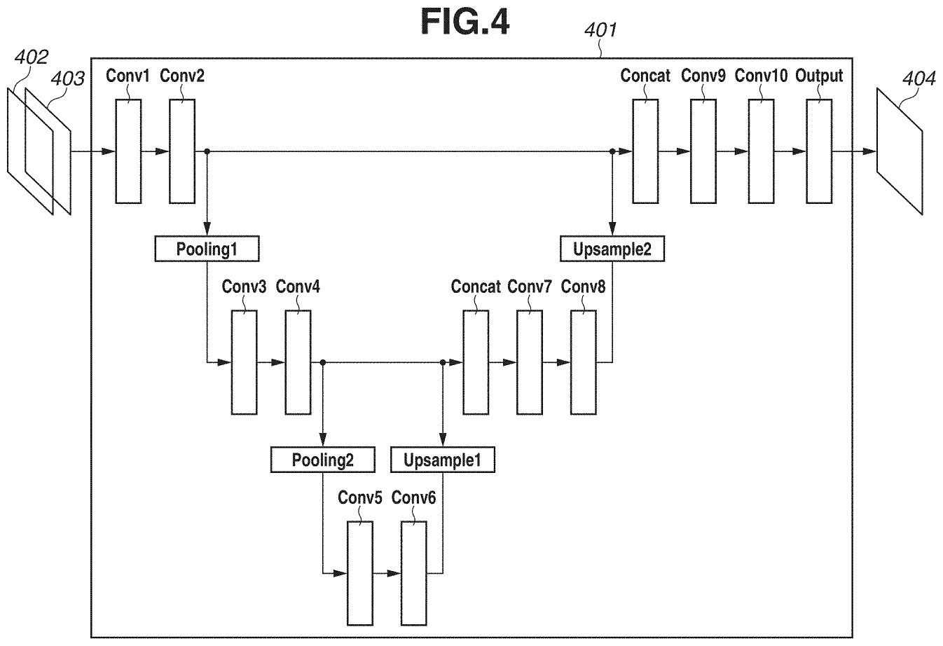

FIG. 4 is a diagram illustrating an example of a neural network 401 that outputs an interaction map estimation result from an input image.

In the example of FIG. 4, two temporally consecutive images 402 and 403 acquired by the input image acquisition unit 203 are input as a tensor linking the images 402 and 403 in a channel direction to the neural network 401. For example, if each of the images 402 and 403 is a red, green, and blue (RGB) image where the width is H and the height is W, a tensor of H×W×6 is input. In the neural network 401, “Conv” represents a convolution layer. “Pooling” represents a pooling layer. “Upsample” represents an upsampling layer. “Concat” represents a connected layer. “Output” represents an output layer. If the tensor of H×W×6 is input to Conv1 of the neural network 401, a calculation process is executed according to the flow in FIG. 4, and an interaction map estimation result 404 of H×W×1 is output from the output layer of the neural network 401.

The description returns to the flowchart in FIG. 3. In step S303, based on the interaction map estimation result acquired by the map estimation unit 204, the state detection unit 205 detects a crowd state composed of a plurality of persons present in the input image. In the present exemplary embodiment, the crowd state indicates whether an abnormal state where a certain person makes a motion different from that of other persons near the certain person occurs. Examples of the abnormal state include motions such as a backward move, an interruption, and a standstill.

The interaction map is calculated by a method described below as a map having a great value at the position where a certain person makes a motion different from that of other persons near the certain person. Accordingly, by a threshold process for comparing a value of the interaction map and a threshold, it can be determined whether a crowd state (abnormal state) occurs.

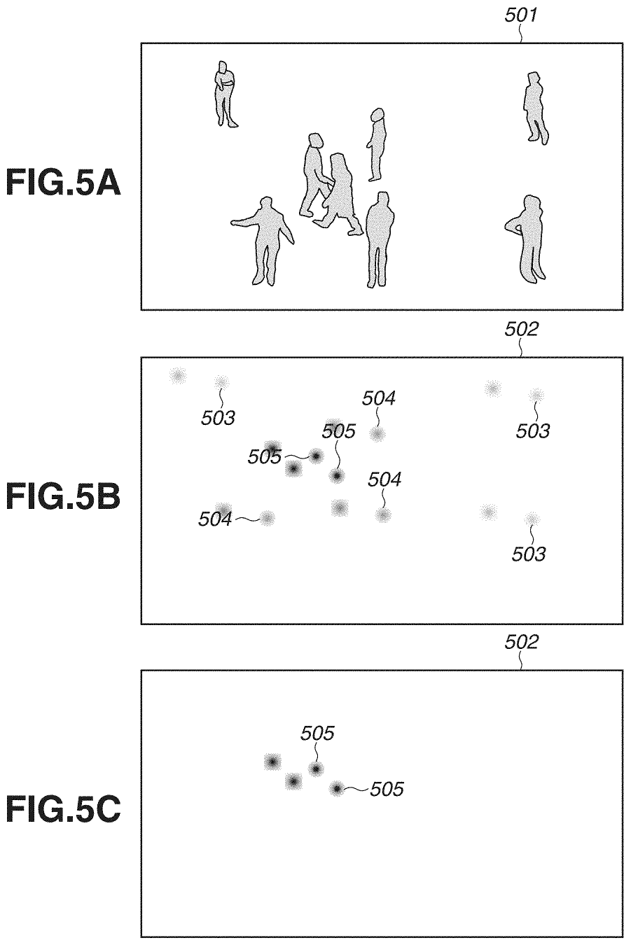

FIGS. 5A and 5B are diagrams illustrating examples of a method for determining, using an interaction map estimation result, whether a crowd state (abnormal state) occurs.

FIG. 5A is a diagram illustrating an example of an input image 501, which is an image as a processing target for detecting a crowd state.

FIG. 5B is a diagram illustrating an example of an interaction map estimation result 502 estimated by the map estimation unit 204 using the input image 501 in which a plurality of persons is present. In the example of FIG. 5B, at portions in the interaction map estimation result 502 that correspond to the positions of the persons in the input image 501, interaction map values 503, 504, and 505 of interactions received by the persons from other persons near the persons are output. In FIG. 5B, the order (relative magnitude relationships) of the interaction map values 503, 504, and 505 is assumed to be the interaction map value 503<the interaction map value 504<the interaction map value 505. The shades of the interaction map values 503, 504, and 505 in FIG. 5B reflect the order of the relative magnitude relationships.

For example, a threshold used in a threshold process for determining the relative magnitude relationships between the above map values is assumed to be a threshold satisfying the map value 504<the threshold<the map value 505. If the threshold process is executed on the interaction map estimation result 502 using the threshold, the result of the threshold process is as illustrated in FIG. 5C. Specifically, in the case of the interaction map estimation result 502, only the interaction map value 505 greater than the threshold remains among the interaction map values 503, 504, and 505. Then, if the result of the example of FIG. 5C is obtained by the threshold process, the state detection unit 205 can detect in the input image 501 a portion where the state where a certain person makes a motion different by a certain amount or more from that of other persons near the certain person occurs, i.e., a crowd state occurs.

The description returns to the flowchart in FIG. 3. In step S304, the display unit 206 displays or outputs the input image acquired by the input image acquisition unit 203, the interaction map estimation result estimated by the map estimation unit 204, and the crowd state detected by the state detection unit 205.

The display unit 206 may simultaneously display or output all of the input image, the interaction map estimation result, and the crowd state, or may display or output some of the input image, the interaction map estimation result, and the crowd state. However, the display unit 206 needs to display or output at least either one of the interaction map estimation result and the crowd state. The display or output destination of the display unit 206 may be the output unit 15 of the image processing apparatus 100, or may be a device present outside the image processing apparatus 100 and connected to the image processing apparatus 100 via the I/F unit 16.

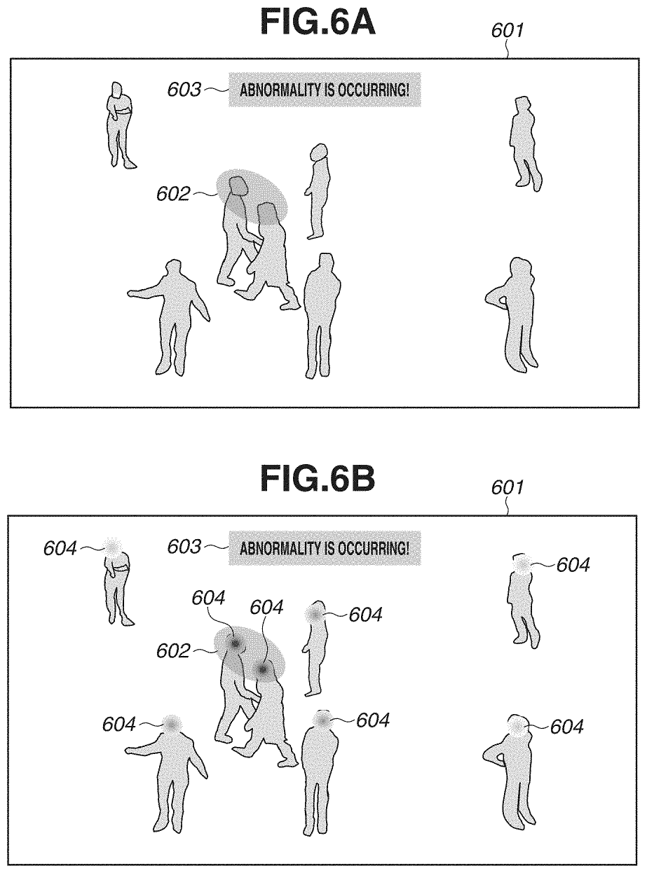

FIGS. 6A and 6B are diagrams illustrating examples of the display or output of the display unit 206.

FIG. 6A is a diagram illustrating an example of a display image 601 in which a highlight display 602 surrounding the occurrence positions (505 and 506) of the crowd state illustrated in FIG. 5C and a warning display 603 indicating the occurrence of the crowd state are displayed in a superimposed manner on the input image in FIG. 5C.

FIG. 6B is a diagram illustrating an example of an image in which an interaction map 604 corresponding to each of the interaction map values 503, 504, and 505 illustrated in FIG. 5B is further displayed in a superimposed manner on the display image 601 in FIG. 6A. In FIG. 6B, the interaction map 604 is displayed in a shading manner corresponding to the interaction map values. More specifically, the interaction map 604 is displayed in a light color at a place where an interaction is small, and is displayed in a dark color at a place where an interaction is great. If an interaction is great, it is indicated that it is more likely that the person makes a motion different from that of other persons near the person, i.e., for example, a backward move, an interruption, or a standstill occurs.

The highlight display 602 in FIGS. 6A and 6B may be a display of which the figure or the color is changed based on the interaction map value in the highlighted region. Alternatively, the highlight display 602 in FIGS. 6A and 6B may be a display of which the display content is changed based on the interaction map value in the highlighted region. For example, in the highlight display 602, characters or an icon representing a level such as safety, attention, warning, or danger may be used. Although the highlight display 602 and the warning display 603 are simultaneously displayed in FIGS. 6A and 6B, either one of the highlight display 602 and the warning display 603 may be displayed, or another type of a highlight display or a warning display may be further added.

Alternatively, the display unit 206 may notify the image analysis apparatus 201 of the crowd state, or may notify a device that gives a notification of a crowd state and is connected to the image analysis apparatus 201 via the I/F unit 16 of the image analysis apparatus 201, of this crowd state. Examples of the device that gives a notification of a crowd state include a device that emits a warning sound such as a buzzer or a siren, a device that emits a voice, lamps such as a rotating light, an indicating light, and a signaling light, a display device such as a digital signage, and mobile terminals such as a smartphone and a tablet.

In the method for outputting the interaction map estimation result from the input image in step S302 in the flowchart in FIG. 3, the image analysis apparatus 201 may use a neural network having the function of storing information regarding an input image of the past within the neural network. Examples of the neural network in this case include a neural network including a long short-term memory (LSTM) layer.

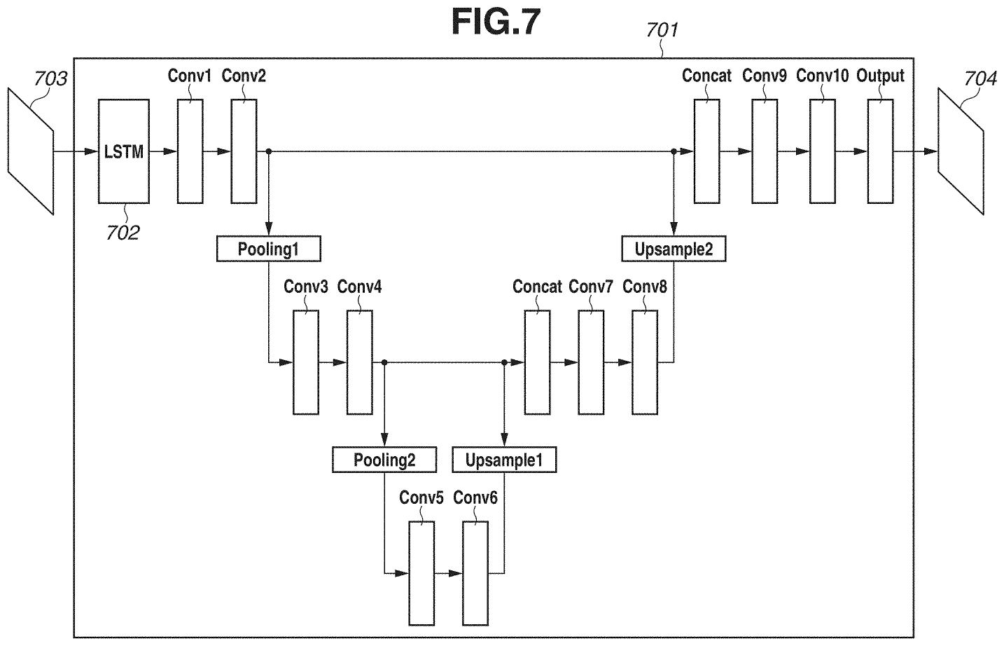

FIG. 7 is a diagram illustrating an example of a neural network 701 including an LSTM layer. In the neural network 701, “Conv”, “Pooling”, “Upsample”, “Concat”, and “Output” are similar to those in the example of FIG. 4. In FIG. 7, an image 703 is input to the neural network 701, a calculation process is executed according to the flow in FIG. 7, and an interaction map estimation result 704 is output from the output layer of the neural network 701.

The neural network 701 in FIG. 7 has a configuration in which an LSTM layer 702 is added immediately before Conv1 of the neural network 401 illustrated in FIG. 4. The LSTM layer 702 can store information regarding an input image input in the past and provide the information to Conv1, and therefore, Conv1 and the subsequent layers of the neural network 701 can use more information than in a case where a particular number of images are input. Thus, it is possible to improve inference accuracy.

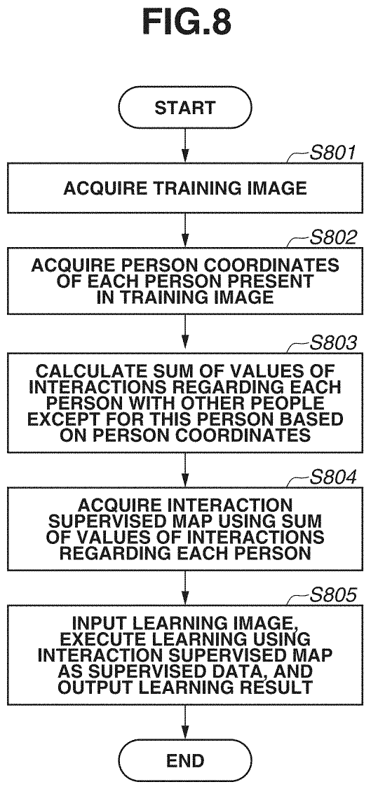

FIG. 8 is a flowchart illustrating an example of a flow of image processing (learning process) performed by the learning apparatus 202 according to the present exemplary embodiment.

In step S801, the training image acquisition unit 207 acquires, as a training image, time-series images obtained by capturing a plurality of objects required for learning. In the present exemplary embodiment, the training image is, for example, a streaming file, a moving image file, a series of image files saved for each frame, or a moving image or images saved in a medium. The training image acquisition unit 207 may acquire, as the training image, a captured image from a solid-state image sensor such as a CMOS sensor or a CCD sensor or a camera on which a solid-state image sensor is mounted, or an image read from the storage device such as an HDD or an SSD or a recording medium.

Next, in step S802, the coordinate acquisition unit 208 acquires the coordinates of each person present in the training image, i.e., person coordinates, from the training image acquired by the training image acquisition unit 207. In the present exemplary embodiment, the person coordinates are the coordinates of a representative point of each person in the training image. For example, the coordinates of the center of the head of the person is set as the person coordinates.

Examples of a method for obtaining the person coordinates from the training image include a method of obtaining the person coordinates by the user operating the operation device of the input unit 14 based on the training image displayed on the output unit 15, i.e., a method of performing an annotation. The annotation may be executed by an operation from outside the learning apparatus 202 via the I/F unit 16. As another method for obtaining the person coordinates from the training image, a method of automatically acquiring the person coordinates, such as performing the process of detecting the center of the head of the person from the training image and acquiring the coordinates of the center of the head, may be used. Further, the person coordinates acquired by the detection process may be displayed on the output unit 15, and the annotation may be executed based on the display of the person coordinates.

In steps S803 and S804, based on the person coordinates acquired by the coordinate acquisition unit 208, the supervised map acquisition unit 209 calculates the sum of the values of interactions regarding each person, and based on the sum of the values of the interactions, the supervised map acquisition unit 209 acquires an interaction supervised map.

In step S803, the supervised map acquisition unit 209 calculates the values of interactions regarding each person with other persons other than the person and obtains the sum of the values of the interactions.

An interaction has a first property that the smaller the angle between the moving direction of each person present in an image and the moving direction of another person different from the person is, the smaller the interaction is, and the greater the angle is, the greater the interaction is. In other words, the first property is such that if the moving directions of certain two persons approximately match each other, the interaction is small. On the other hand, if the moving directions are opposite to each other, the interaction is great. More specifically, an interaction map in this case is a map in which a numerical value is assigned to the position of an object of interest among a plurality of objects present in an input image so that the smaller the angle between the moving direction of the object of interest and the moving direction of another object different from the object of interest is, the smaller the numerical value is, and the greater the angle is, the greater the numerical value is.

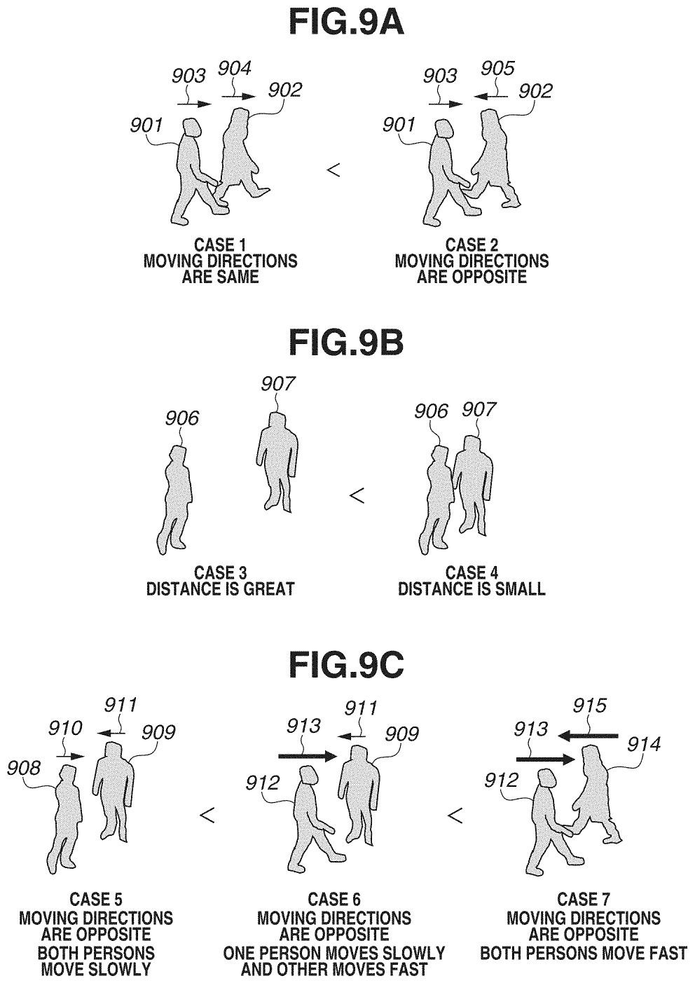

FIG. 9A is a diagram illustrating an example of the first property of the interaction. As illustrated in a case 1 in FIG. 9A, if a moving direction 903 of a person 901 and a moving direction 904 of a person 902 match each other, the angle between the moving directions 903 and 904 is 0°, and therefore, the interaction is small. On the other hand, as illustrated in a case 2 in FIG. 9A, if the moving direction 903 of the person 901 and a moving direction 905 of the person 902 are exactly opposite to each other, the angle between the moving directions 903 and 905 is 180°, and therefore, the interaction is great.

Based on the first property, in a situation in which persons move in different directions from each other, i.e., a phenomenon such as a collision between persons or an interruption in a crowd is likely to occur, the interaction is great.

In FIGS. 9A to 9C, an inequality sign indicates the relative magnitude relationship between interactions between two persons in the positional relationship between the two persons and in the states of motion vectors of the two persons. In FIGS. 9A to 9C, an arrow near a person indicates the moving speed of the person. More specifically, the arrow indicates that the thinner and shorter the arrow is, the smaller the absolute value of the moving speed is, i.e., the slower the movement is. On the other hand, the arrow indicates that the thicker and longer the arrow is, the greater the absolute value of the moving speed is, i.e., the faster the movement is.

The interaction may also have a second property that the greater the distance between each person present in an image and another person different from the person is, the smaller the interaction is, and the smaller the distance is, the greater the interaction is. More specifically, an interaction map in this case is a map in which a numerical value is assigned to the position of an object of interest among a plurality of objects present in an input image so that the greater the distance between the object of interest and another object different from the object of interest is, the smaller the numerical value is, and the smaller the distance is, the greater the numerical value is.

FIG. 9B is a diagram illustrating an example of the second property of the interaction. As illustrated in a case 3 in FIG. 9B, if the distance between persons 906 and 907 is great, the interaction is small. On the other hand, as illustrated in a case 4 in FIG. 9B, if the distance between the persons 906 and 907 is small, the interaction is great.

Based on the second property, in a situation in which persons approach each other, i.e., a phenomenon such as a collision between persons is likely to occur, the interaction is great.

The interaction may also have a third property that the slower the moving speed of each person is, the smaller the interaction is, and the faster the moving speed of each person is, the greater the interaction is. More specifically, an interaction map in this case is a map in which a numerical value is assigned to the position of an object of interest among a plurality of objects present in an input image so that the slower the speed of the movement of the object of interest is, the smaller the numerical value is, and the faster the speed of the movement of the object of interest is, the greater the numerical value is.

FIG. 9C is a diagram illustrating an example of the third property of the interaction and illustrates an example in which the moving directions of two persons are opposite to each other. As illustrated in a case 5 in FIG. 9C, if a speed 910 of the movement of a person 908 and a speed 911 of the movement of a person 909 are both small, i.e., if the moving speeds of the persons 908 and 909 are both slow, the interaction is small. As illustrated in a case 6 in FIG. 9C, if the speed 911 of the movement of the person 909 is small and a speed 913 of the movement of a person 912 is great, i.e., if one of the persons 909 and 912 is slow and the other is fast, the interaction is greater than that in the example of the case 5. As illustrated in a case 7 in FIG. 9C, if the speed 913 of the movement of the person 912 and a speed 915 of the movement of a person 914 are both great, i.e., the movements of the persons 912 and 914 are both fast, the interaction is greater than that in the example of the case 6. Accordingly, in the example of FIG. 9C, the order of the magnitudes of the interactions is case 5<case 6<case 7.

Based on the third property, in a situation in which the movement of each person is fast, and damage is likely to be great if persons collide with each other, the interaction is great.

A description is given of a technique for calculating an interaction as described above. Examples of a mathematical expression for calculating an interaction Uᵢⱼ having all of the first, second, and third properties regarding certain two persons i and j include the following equation (1).

In equation (1), vᵢ is a motion vector of the person i, vⱼ is a motion vector of the person j, θ is the angle between the motion vectors vᵢ and vⱼ, rᵢⱼ is a distance between the persons i and j, C is a constant, and n is a degree.

$${U}_{i j} = C \frac{\vert {v}_{i} \vert \vert {v}_{j} \vert sin ( \frac{θ}{2} )}{{r}_{ij}^{n}} \qquad ( 1 )$$

Examples of a method for acquiring a motion vector include a method of, in a case where the person coordinates of a certain single person at a time t1 are p1 and the person coordinates at a time t2 after the time t1 are p2, obtaining a vector from the person coordinates p1 toward p2 as a motion vector. Examples of the method also include a method of, in a case where the person coordinates are obtained from a plurality of training images, calculating a velocity vector by an interpolation method or a difference method using the relationships between the person coordinates and times, and obtaining the velocity vector as a motion vector.

The distance rᵢⱼ between the persons i and j may be, for example, the distance between the person coordinates of the person i and the person coordinates of the person j, or may be the distance between the motion vectors vᵢ and vⱼ, e.g., the distance between the median of the motion vector vᵢ and the median of the motion vector vⱼ. Examples of metrics for the distance include the Euclidean distance. In a case where a portion through which persons can pass is limited by a passage, the distance along the passage may be used.

In the above-described equation (1), the first property is represented by a mathematical expression of sin(θ/2).

The range of the angle θ between the motion vectors vᵢ and vⱼ may be determined, taking into account the second property, so that sin(θ/2) monotonically increases with respect to θ. For example, in the case of equation (1), the range of the angle θ may be [0°, 180° ] or [0, π].

To provide the first property, another mathematical expression which behaves similarly to sin(θ/2), i.e., in which the value increases if θ increases, may be used instead. In this case, examples of another mathematical expression include θ itself and the power of θ.

Examples of yet another mathematical expression include a method using a mathematical expression using the vector calculation of the motion vectors vᵢ and vⱼ instead of sin(θ/2). Examples of the vector calculation of the motion vectors vᵢ and vⱼ include a method using an inner product vᵢ·vⱼ of the motion vectors vᵢ and vⱼ. Examples of the mathematical expression using the inner product vᵢ·vⱼ of the motion vectors vᵢ and vⱼ include a method of calculating vᵢ·vⱼ/(|vᵢ∥vⱼ|). If θ is in the range of [0°, 180°], vᵢ·vⱼ/(|vᵢ∥vⱼ|) takes the range of [1, −1]. Thus, if {1−vᵢ·vⱼ/(|vᵢ∥vⱼ|)}/2 is calculated, the angle θ between the motion vectors vᵢ and vⱼ=0°, and therefore, the inner product vᵢ·vⱼ of the motion vectors vᵢ and vⱼ is 0. If θ=180°, the inner product vᵢ·vⱼ of the motion vectors vᵢ and vⱼ is 1.

Alternatively, the above-described expression of {1−vᵢ·vⱼ/(|vᵢ∥vⱼ|)}/2 may be used instead of sin(θ/2). To be exact, {1−vᵢ·vⱼ/(|vᵢ∥vⱼ|)}/2 coincides with sin²(θ/2) based on a half-angle equation, and therefore, examples of yet another mathematical expression also include a method of using the positive square root of {1−vᵢ·vⱼ/(|vᵢ∥vⱼ|)}/2 instead of sin(θ/2).

In the above-described equation (1), the second property is represented by a mathematical expression of 1/rᵢⱼⁿ. Accordingly, the distance dependence of the interaction Uᵢⱼ can be adjusted by the value of the order n. For example, if the order n is increased, the interaction between persons remote from each other becomes smaller. Thus, the interaction between persons close to each other can be further emphasized. However, to satisfy the first property, the order n needs to satisfy n>0.

To provide the second property, another mathematical expression which behaves similarly to 1/rᵢⱼⁿ, i.e., which monotonically decreases with respect to rᵢⱼ, may be used instead. Examples of another mathematical expression include a mathematical expression of exp(−ζrᵢⱼ) or exp(−αrᵢⱼ²). In this case, exp(−ζrᵢⱼ) and exp(−αrᵢⱼ²) have an advantage that overflow and division by zero do not occur as in 1/rᵢⱼⁿ even if rᵢⱼ becomes small. The coefficients ζ and α function similarly to the order n in 1/rᵢⱼⁿ. For example, if ζ or α is increased, the interaction between persons remote from each other becomes smaller. Accordingly, the interaction between persons close to each other can be emphasized. However, to satisfy the second property, ζ needs to satisfy ζ>0. Further, to satisfy the second property, α needs to satisfy α>0.

In the above-described equation (1), the third property is represented by a mathematical expression of |vᵢ∥vⱼ|.

To provide the third property, another mathematical expression which behaves similarly to |vᵢ∥vⱼ|, i.e., which increases if |vᵢ| increases, and increases if |vⱼ| increases, may be used instead. Examples of another mathematical expression include a mathematical expression of |vᵢ|^{p}|vⱼ|^{q}. However, to satisfy the first property, p and q need to satisfy p>0 and q>0.

To satisfy all of the first, second, and third properties, the constant C in the above-described equation (1) needs to satisfy C>0. Based on the value of the constant C, the range of values that can be taken by the interaction Uᵢⱼ can be adjusted.

In the third property, for example, if the person i stands still or stays and the person j moves at a high speed near the person i, the interaction may be calculated to be small because the person i stands still, depending on the form of the calculation equation for the interaction.

In the example of the equation (1), the interaction Uᵢⱼ is proportional to the product of |vᵢ| and |vⱼ|. For example, if either one of |vᵢ| and |vⱼ| is 0, i.e., if the person i stands still or stays and the person j moves at a high speed near the person i, the interaction is 0.

As described above, in order that the interaction is great even if the person i stands still or stays and the person j moves at a high speed near the person i, the interaction may have a property that the interaction is not 0 even if the person i stands still.

Examples of a mathematical expression having the property that the interaction is not 0 even if the person i stands still include max(|vᵢ|,|vⱼ|), |vᵢ|+|vⱼ|, and exp(|vᵢ|)exp(|vⱼ|). |vᵢ∥vⱼ| in the above-described equation (1) is replaced with these mathematical expressions taken as examples, whereby it is possible to provide the property that the interaction is not 0 even if the person i stands still.

If a person stays, the person who stays is not in a completely still state, and is often accompanied by a minute fluctuation such as forward, backward, leftward, and rightward shakes of the head or a change in the direction of the face.

In such a case, |vᵢ| and |vⱼ| and the angle θ between the motion vectors vᵢ and vⱼ, which are derived from a motion vector of the person, are likely to reflect not the actual motion of the person, but a minute fluctuation as described above.

Thus, if an attempt is made to detect an abnormality such as a backward move or an interruption by directly using a motion vector obtained by an optical flow, and in a case where the person stays, the optical flow is disrupted by a minute fluctuation. As a result, a decrease in the accuracy of detection of an abnormality cannot be avoided.

In response, to avoid the decrease in the accuracy, in addition to the first, second, and third properties, a fourth property may be provided to the calculation equation for the interaction.

The fourth property is such that, between two persons present in an image, the slower the movement of the person moving more slowly is, the smaller the moving direction dependence of the interaction is, and on the other hand, the faster the movement is, the greater the moving direction dependence of the interaction is. The moving direction dependence in this case is the first property.

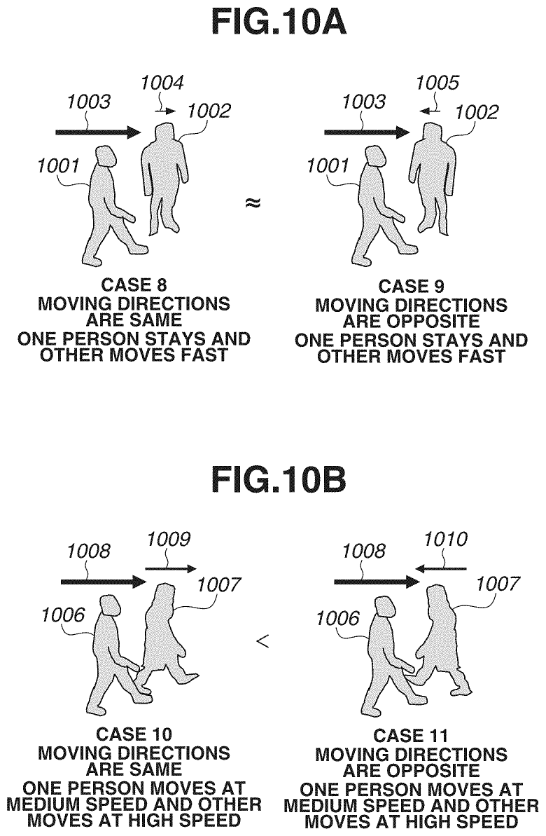

FIGS. 10A and 10B are diagrams illustrating examples of the fourth property.

In cases 8 and 9 illustrated in FIG. 10A, a speed 1003 of the movement of a person 1001 is the same in the both cases 8 and 9 and is a high speed. On the other hand, a speed 1004 of the movement of a person 1002 in the case 8 and a speed 1005 of the movement of the person 1002 in the case 9 are both minute motions accompanying a stay.

In the case 8, a moving direction 1004 of the person 1002 who stays is the same as a moving direction 1003 of the person 1001. On the other hand, in the case 9, a moving direction 1005 of the person 1002 who stays is opposite to the moving direction 1003 of the person 1001.

In both of the cases 8 and 9, the motions of the person 1002 are minute. Thus, based on the fourth property, the moving direction dependence of the person 1002 in the interactions is small. In other words, the contribution of the first property to the interactions is small. Thus, in the cases 8 and 9, regardless of the directions of the minute motions of the person 1002, the magnitudes of the interactions are determined mostly based on the speeds of the movements of the person 1001 who moves fast. Thus, in the cases 8 and 9, the magnitudes of the interactions are almost equal to each other.

In cases 10 and 11 illustrated in FIG. 10B, a speed 1008 of the movement of a person 1006 is the same in both of the cases 10 and 11 and is a high speed. A speed 1009 of the movement of a person 1007 in the case 10 and a speed 1010 of the movement of the person 1007 in the case 11 are both medium speeds. A “medium speed” means that the speed is slower than the speed 1008 of the movement of the person 1006 who moves at a high speed, but is faster than the speeds 1004 and 1005 of the minute motions accompanying the stays of the person 1002 in the cases 8 and 9.

In the case 10, a moving direction 1008 of the person 1006 is the same as a moving direction 1009 of the person 1007. On the other hand, in the case 11, the moving direction 1008 of the person 1006 is opposite to a moving direction 1010 of the person 1007.

In both of the cases 10 and 11, the person 1007 moves at medium speeds. Thus, the moving direction dependence of the person 1007 in the interactions is greater than that in the cases 8 and 9. In other words, the contribution of the first property to the interactions is great.

Thus, in the cases 10 and 11, the magnitudes of the interactions depend also on the directions of the movements of the person 1007 in addition to the directions of the movements of the person 1006.

In the case 10, the moving direction 1008 of the person 1006 and the moving direction 1009 of the person 1007 are the same as each other. Thus, based on the first property, the magnitude of the interaction is small. On the other hand, in the case 11, the moving direction 1008 of the person 1006 and the moving direction 1010 of the person 1007 are opposite to each other. Thus, based on the first property, the magnitude of the interaction is great.

As a result, in the cases 10 and 11, the order of the magnitudes of the interactions is case 10<case 11.

According to the above description using the examples of FIGS. 10A and 10B, based on the fourth property, between certain two persons, the slower the movement of the person is, the smaller the moving direction dependence of the interaction is. Thus, in a case where one of the two persons makes a minute fluctuation accompanying a stay, the person can be regarded as making a motion with a small amount of movement. Thus, the direction of the fluctuation of the person hardly contributes to the value of the interaction.

Further, based on the third property, the slower the movement of the person is, i.e., the smaller the amount of movement per unit time is, the smaller the interaction is. A movement caused by a minute fluctuation is a motion with a small amount of movement, and therefore, the interaction is small no matter which direction the direction of the movement is.

Thus, it can be said that, based on the third and fourth properties, the value of the interaction is not greatly influenced by a minute fluctuation. Therefore, using the value of the interaction, it is possible to prevent a decrease in the accuracy of detection of an abnormality due to a person who stays.

As a mathematical expression for calculating the interaction Uᵢⱼ in which the interaction is not 0 even if one of the two persons stays in the third property, and which has the fourth property in addition to the first, second, and third properties, various mathematical expressions are possible.

Examples of the various mathematical expressions include the following equation (2). In equation (2), vᵢ is a motion vector of the person i, vⱼ is a motion vector of the person j, θ is an angle between vᵢ and vⱼ, rᵢⱼ is a distance between the persons i and j, C and k are constants, and n is an order. In equation (2), the definitions of items other than the constant k are the same as those in equation (1).

$${U}_{i j} = C \frac{max ( \vert {v}_{i} \vert , \vert {v}_{j} \vert ) \{ 1 + k \cdot min ( \vert {v}_{i} \vert , \vert {v}_{j} \vert ) sin ( \frac{θ}{2} ) \}}{{r}_{ij}^{n}} \qquad ( 2 )$$

In equation (2), the property that the interaction is not 0 even if one of the two persons stays in the third property is represented by a mathematical expression of max(|vᵢ|,|vⱼ|).

Alternatively, the property that the interaction is not 0 even if one of the two persons stays in the third property may be provided by using another mathematical expression that behaves similarly to the mathematical expression of max(|vᵢ|,|vⱼ|). Examples of another mathematical expression include |vᵢ|+|vⱼ| and exp(|vᵢ|)exp(|vⱼ|).

In equation (2), the fourth property is represented by a mathematical expression of {1+k·min(|vᵢ|,|vⱼ|)sin(θ/2)}. In this mathematical expression, “·” represents a scalar product. For example, if |vⱼ|>|vᵢ|˜0 in a case where the person i stays and the person j moves at a high speed, the value of the mathematical expression is mostly 1, regardless of θ. Thus, the interaction Uᵢⱼ is not influenced by the direction of a minute motion accompanying the stay of the person i.

To satisfy the second property, the constant k needs to satisfy k>0.

By adjusting constant k, the θ dependence of the interaction Uᵢⱼ can be adjusted.

For example, by increasing the constant k, in a case where the moving directions of persons are different from each other, the value of the interaction can be made greater. When the constant k is changed, it is desirable to also simultaneously change the constant C so that the range of values to be taken by the interaction Uᵢⱼ does not greatly change.

To provide the fourth property, another mathematical expression that behaves similarly to the mathematical expression of {1+k·min(|vᵢ|,|vⱼ|)sin(θ/2)} may be used. Examples of another mathematical expression include a mathematical expression of {1+k·θ·min(|vᵢ|,|vⱼ|)}. In this mathematical expression, “·” represents a scalar product.

In a case where 1/rᵢⱼⁿ is used in the calculation equation for the interaction to satisfy the first property, equations having a buffer value b as in equations (3) and (4) may be used to prevent overflow and division by zero that occur when rᵢⱼ is small.

$$\begin{matrix}{U}_{i j} = C \frac{\vert {v}_{i} \vert \vert {v}_{j} \vert sin ( \frac{θ}{2} )}{{r}_{ij}^{n} + b} & ( 3 ) \\ {U}_{i j} = C \frac{max ( \vert {v}_{i} \vert , \vert {v}_{j} \vert ) \{ 1 + k \cdot min ( \vert {v}_{i} \vert , \vert {v}_{j} \vert ) sin ( \frac{θ}{2} ) \}}{{r}_{ij}^{n} + b} & ( 4 )\end{matrix}$$

It is desirable that the buffer value b should be a minute value that does not greatly influence the calculation of the interaction, and does not make the value of the interaction extremely great when rᵢⱼ is small.

Other examples of equations (3) and (4) include equations using 1/(rᵢⱼ+b)ⁿ where the buffer value b is included within the power of n.

Using a method of calculating an interaction between two persons under the above-described definitions, the learning apparatus 202 can calculate interactions regarding each person present in a training image with other persons other than the person and obtain the sum of the interactions.

For example, an i-th person among N persons present in the training image is a person i. The learning apparatus 202 calculates an interaction Uᵢⱼ regarding the person i with another person j other than the person i. A sum Uᵢ of the values of the interactions received by the person i from other persons other than the person i can be calculated by equation (5).

Uᵢ=Σ_{j=1,j≠i}^{N}Uᵢⱼ (5)

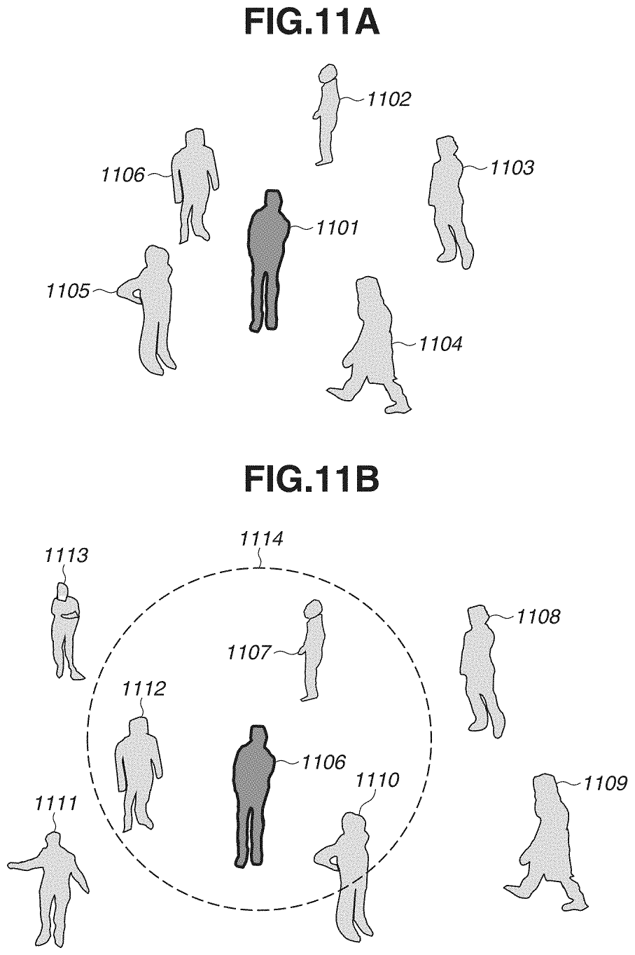

FIGS. 11A and 11B are diagrams illustrating examples of the calculation of the interactions by equation (5).

FIG. 11A is a diagram illustrating an example in which the sum of the values of interactions received by a certain single person 1101 from other persons other than the person 1101 is calculated.

In the example of FIG. 11A, a sum U₁ of the values of interactions regarding the person 1101 is calculated as the sum of the values of interactions with five persons, i.e., other persons 1102, 1103, 1104, 1105, and 1106, except for the person 1101.

It is considered that, based on the first property of the interaction, an interaction with a person remote from the person i can be ignored. Thus, using a set D of the plurality of other persons j present near the person i, the sum Uᵢ of the values of the interactions regarding the person i may be calculated by equation (6).

Uᵢ=Σ_{j∈D}Uᵢⱼ (6)

FIG. 11B is a diagram illustrating an example of the calculation of the interactions by using equation (6) and illustrates an example in which, using a set of a plurality of other persons present near a certain single person 1106, the sum of the values of interactions regarding the person 1106 is calculated.

In FIG. 11B, a sum U₁ of the values of interactions regarding the person 1106 is calculated as the sum of the values of interactions with persons 1107, 1110, and 1112 included in a set D 1114, except for the person 1106.

On the other hand, in FIG. 11B, persons 1108, 1109, 1111, and 1113 present outside the set D 1114 are excluded from the calculation of the sum of the values of the interactions.

Based on the method using the calculation by equation (6), particularly, in a case of a congested crowd including a very large number of persons, it is possible to greatly reduce the amount of calculation of the sum of the values of interactions.

Using the above-described equation (5) or (6), the learning apparatus 202 calculates the sums Uᵢ of the values of interactions regarding all the persons present in the training image.

Examples of a method for obtaining the set D include a method of, as in the example of FIG. 11B, obtaining a set of persons present within a predetermined radial distance d from the person 1106 as the set D.

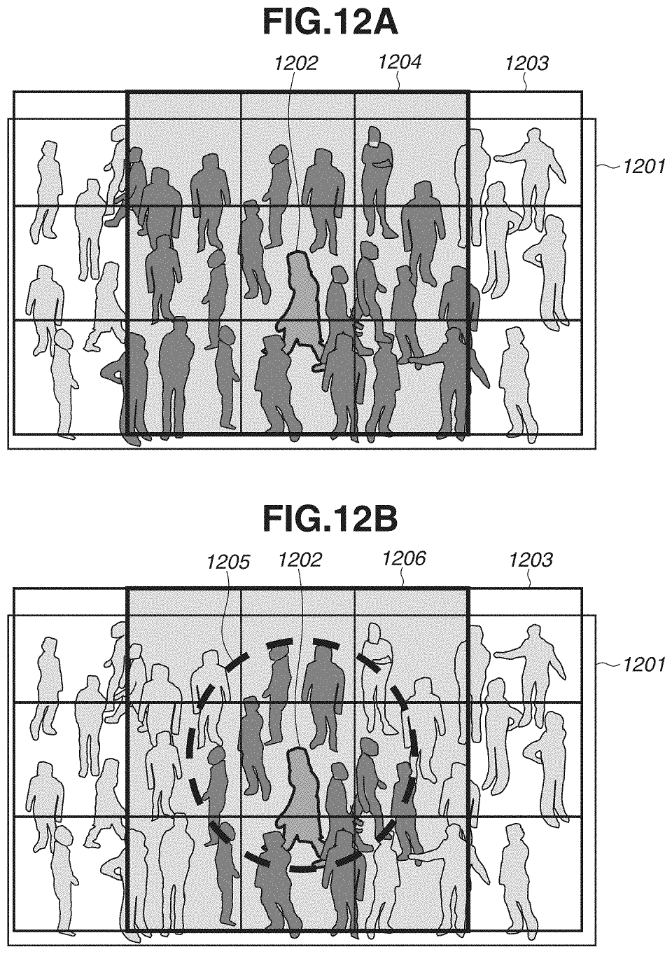

As another method for obtaining the set D, for example, a method as illustrated in FIG. 12A may be used.

FIG. 12A is a diagram illustrating an example in which a set of other persons present near a certain single person is obtained by dividing the set of other persons into any grid squares. In the example of FIG. 12A, a training image 1201 is divided into a group of grid squares 1203 centered on a person 1202 regarding which the sum of the values of interactions is to be obtained. Next, a set of persons present in a partial group of grid squares 1204 composed of grid squares including the person 1202 and grid squares adjacent to the grid squares including the person 1202 is obtained as the set D. In the example of FIG. 12A, the adjacent grid squares are other grid squares sharing the sides and the vertices of the grid squares including the person 1202. A person present in a grid square is, for example, a person with the person coordinates being present in the grid square. In the example of FIG. 12A, the person coordinates are the coordinates of the center of the head of the person.

As yet another method for obtaining the set D, for example, a method in the example of FIG. 12B may be used. FIG. 12B is a diagram illustrating an example in which a set of other persons present near a certain single person is divided into any grid squares and obtained based on the distances from the person. In the example of FIG. 12B, similarly to the example of FIG. 12A, the training image 1201 is divided into the group of grid squares 1203. Next, in the group of grid squares 1203, a partial group of grid squares 1206 present within a range 1205 of a distance d from the person 1202 is selected, and a set of persons present within the range 1205 of the distance d from the person 1202 among persons present in the partial group of grid squares 1206 is obtained as the set D. Examples of a method for selecting a partial group of grid squares present within the distance d from the person 1202 include a method of selecting grid squares having regions overlapping the range 1205 of the radius d with the person 1202 as a center. Similarly to the example of FIG. 12A, a person present in a grid square is a person with the person coordinates being present in the grid square, and the person coordinates are the coordinates of the center of the head of the person.

In the methods described with reference to FIGS. 12A and 12B, when the training image 1201 is divided into the group of grid squares 1203, it is desirable to construct in advance a list of persons included in each grid square included in the group of grid squares 1203. In this way, by creating the list, in a situation where the image capturing range of the training image is wide and many persons are present in the training image, the search range of persons present within the distance d from the certain person can be limited to the range of the partial group of grid squares 1204 or the partial group of grid squares 1206. Thus, it is possible to speed up the search.

The description returns to the flowchart in FIG. 8. In step S804, using the sums Uᵢ of the values of the interactions calculated regarding all the persons present in the training image, the supervised map acquisition unit 209 creates and acquires an interaction supervised map.

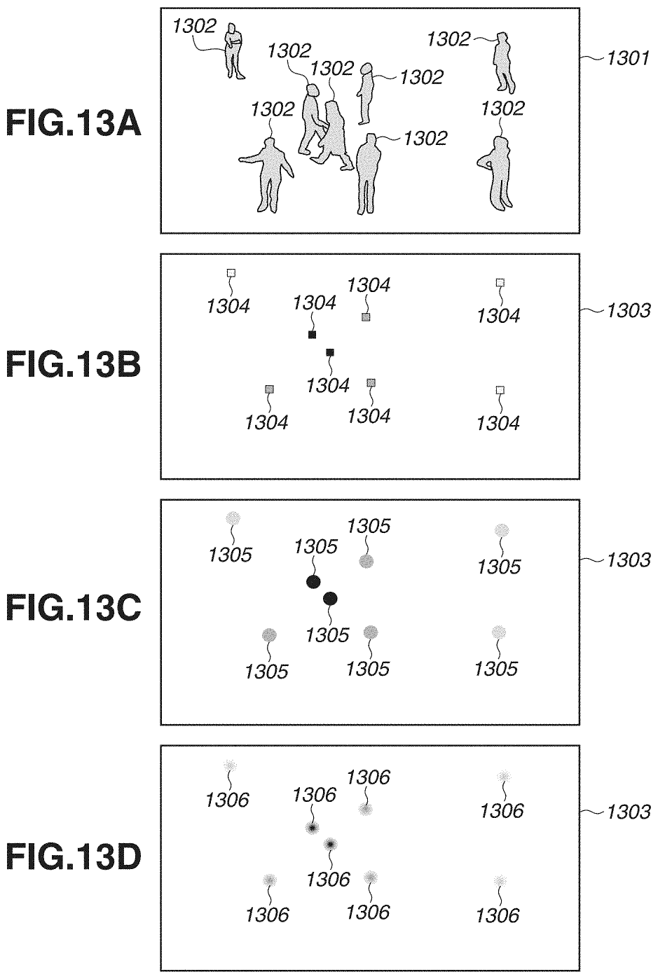

FIGS. 13A to 13D are diagrams illustrating examples of a training image and a method for creating an interaction supervised map.

FIG. 13A is a diagram illustrating an example of a method for creating an interaction supervised map regarding a group of persons 1302 present in a training image 1301.

In FIG. 13A, first, the supervised map acquisition unit 209 prepares an initial value map 1303, which is of the same size as that of the training image 1301 and in which all the pixel values are zero.

Examples of the method for creating an interaction supervised map include a method of, as in FIG. 13B, overwriting the values of a group of pixels 1304 corresponding to the person coordinates of persons in the group of persons 1302, with the values of interactions regarding the persons on the initial value map 1303.

Other examples of the method for creating an interaction supervised map include a method of, as in FIG. 13C, overwriting the inside of a group of circular regions 1305 with respective centers being on the person coordinates of persons in the group of persons 1302 and the respective radii being the head sizes of the persons, with the respective values of interactions regarding the persons on the initial value map 1303.

Other examples of the method for creating an interaction supervised map include a method of, as in FIG. 13D, placing a group of Gaussian functions 1306 with respective centers being on the person coordinates of persons in the group of persons 1302 and with the respective radii corresponding to the head sizes of the persons on the initial value map 1303. The group of Gaussian functions is set so that the integral value of each Gaussian function coincides with the value of an interaction regarding each person.

Examples of a method for obtaining the head sizes include a method of, based on the training image displayed on the output unit 15, setting the head sizes through an operation on the operation device connected to the input unit 14. Other examples of the method for obtaining the head sizes include a method of automatically detecting and obtaining the head sizes from the training image.

The description returns to the flowchart in FIG. 8. In step S805, the learning unit 210 learns a parameter set to which the training image is input as input data and which outputs the interaction supervised map from the training image using the interaction supervised map as supervised data. Then, the learning unit 210 outputs the parameter set.

In the present exemplary embodiment, the learning process of the learning unit 210 is performed by the following procedure.

First, using the same method as the map estimation unit 204, the learning unit 210 obtains an interaction map estimation result using a parameter set of a neural network to which the training image is input and which outputs the interaction supervised map from the training image.

Next, based on the difference between the map values of the interaction map estimation result and the interaction supervised map corresponding to the training image, the learning unit 210 calculates a loss value using a loss function.

Then, based on the loss value, the learning unit 210 updates the parameter set of the neural network by using an error backpropagation method, thereby advancing the learning.

Then, the learning unit 210 repeats the above-described learning, stops the learning when the loss value falls below a threshold for the loss value that has been set in advance, and outputs, as a learning result, the parameter set of the neural network at the time when the learning is stopped.

As the loss function, various known loss functions can be used. Examples of the loss function include the mean squared error (MSE) and the mean absolute error (MAE).

The interaction supervised map as the supervised data acquired by the supervised map acquisition unit 209 has a feature that if the number of persons in the training image is particularly small, the interaction supervised map has a value of 0 or a value close to 0 in most regions.

In a case where such a sparse map with a majority of 0 is used as the supervised data, the loss function may not be converged by the MSE or the MAE. In such a case, it is desirable to perform learning using binary cross entropy for the loss function. In a case where the binary cross entropy is used for the loss function, the range of the interaction supervised map needs to be 0 or more and 1 or less. However, the value of the interaction Uᵢⱼ illustrated in the above equations (1), (2), (3), and (4) can be 1 or more. Thus, in this case, the binary cross entropy can be used for the loss function by converting the value of each pixel of the interaction supervised map by a function with which the range falls within the range of 0 or more and 1 or less in a region where the domain is 0 or more, such as a softmax function.

As described above, in the present exemplary embodiment, without estimating a motion vector or an optical flow that causes a decrease in the accuracy of estimation of a moving direction, an interaction map having a great value at the position where a certain person makes a motion different from that of other persons near the certain person is directly estimated from an image. Then, in the present exemplary embodiment, based on the relative magnitude of the value of the interaction map, an abnormal state is detected. In this way, according to the present exemplary embodiment, it is possible to detect an abnormal state such as a stay or a backward move with high accuracy.

In the above-described exemplary embodiment, two temporally consecutive images are used as an input image by the input image acquisition unit 203. Alternatively, three or more temporally consecutive images may be acquired and used as an input image. In a case where three or more temporally consecutive images are input, for example, the three or more images may be input as a tensor linking the three or more images in a channel direction to the neural network 401 illustrated in FIG. 4.

As a variation of the above-described exemplary embodiment, a method of acquiring a part of an input image acquired by the input image acquisition unit 203 as a partial image and using the partial image as an input image to be a processing target for detecting a crowd state may be used. Examples of the partial image include a partial image including a region through which persons can pass in the input image, and a partial image excluding a region through which persons do not pass in the input image. As another example of the partial image, an image obtained by extracting a region of interest as a monitoring target from the input image may be used. Examples of the region of interest include image regions of a doorway, a pedestrian crosswalk, a railroad crossing, a ticket gate, a cash desk, a ticket counter, an escalator, stairs, and a station platform.

The partial image may be acquired by the user operating the operation device connected to the input unit 14 based on an image displayed on the output unit 15, or may be acquired by operating the image processing apparatus 100 from outside the image processing apparatus 100 via the I/F unit 16. Alternatively, the partial image may be automatically acquired using a method such as object recognition or region segmentation. As the method for the object recognition or region segmentation, various known methods can be used. Examples of the various known methods include machine learning, deep learning, and semantic segmentation.

In the above-described exemplary embodiment, a person is taken as an example of a target object. However, the target object is not limited to a person, and may be any object. Examples of the target object include vehicles such as a bicycle and a motorcycle, wheeled vehicles such as a car and a truck, and an animal such as a barnyard animal.

The configuration regarding the image processing according to the above-described exemplary embodiment or the processing of the flowcharts may be achieved by a hardware configuration, or may be achieved by a software configuration by, for example, a CPU executing the program according to the present exemplary embodiment. Alternatively, a part of the configuration regarding the image processing according to the above-described exemplary embodiment or the processing of the flowcharts may be achieved by a hardware configuration, and the rest of the configuration regarding the image processing according to the above-described exemplary embodiment or the processing of the flowcharts may be achieved by a software configuration. The program for the software configuration may be not only prepared in advance, but also acquired from a recording medium such as an external memory (not illustrated) or acquired via a network (not illustrated).

In the above-described exemplary embodiment, an example has been taken in which a neural network is used when the map estimation unit 204 outputs an interaction map estimation result from an input image. Alternatively, a neural network may be applied to another component. For example, a neural network may be used in a state detection process performed by the state detection unit 205.

A program for achieving one or more functions in a control process can be supplied to a system or an apparatus via a network or a storage medium and the one or more functions can be achieved by being read and executed by one or more processors of a computer of the system or the apparatus.

All the above-described exemplary embodiments merely illustrate specific examples for carrying out the disclosure, and the technical scope of the disclosure should not be interpreted in a limited manner based on these exemplary embodiments. In other words, the disclosure can be carried out in various ways without departing from the technical idea or the main feature of the disclosure.

### Other Embodiments

Embodiment(s) of the disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2020-187239, filed Nov. 10, 2020, which is hereby incorporated by reference herein in its entirety.

What is claimed is:

1. An image processing apparatus comprising:
an input image acquisition unit configured to acquire, as an input image, time-series images obtained by capturing a plurality of objects;
a map acquisition unit configured to acquire an interaction map that indicates a difference between a first motion of a first object and a second motion of a second object at respective positions of each of the plurality of objects in the input image, by using the input image; and
a state detection unit configured to detect a state of the first motion present in the input image by using the interaction map,
wherein the interaction map is estimated based on a trained model for estimating the interaction map and a parameter set prepared in advance.

2. The image processing apparatus according to claim 1, wherein the parameter set is learned based on the interaction map to which a value of an interaction indicating the difference between the first motion and the second motion is assigned.

3. The image processing apparatus according to claim 2, wherein the interaction map indicates a sum of the values of the interactions at the position where each of the plurality of objects is present in the input image.

4. The image processing apparatus according to claim 3, wherein the state detection unit detects that the state of the first motion is an abnormality at a position where the value of the interaction is greater than a predetermined threshold.

5. The image processing apparatus according to claim 2, wherein the interaction map is a map in which a numerical value is assigned to a position of an object of interest among the plurality of objects present in the input image so that the smaller an angle between a first moving direction of the object of interest and a second moving direction of the second object different from the object of interest is, the smaller the numerical value is, and the greater the angle is, the greater the numerical value is.

6. The image processing apparatus according to claim 2, wherein the interaction map is a map in which a numerical value is assigned to a position of an object of interest among the plurality of objects present in the input image so that the greater a distance between the object of interest and another object different from the object of interest is, the smaller the numerical value is, and the smaller the distance is, the greater the numerical value is.

7. The image processing apparatus according to claim 2, wherein the interaction map is a map in which a numerical value is assigned to a position of an object of interest among the plurality of objects present in the input image so that the slower a speed of a movement of the object of interest is, the smaller the numerical value is, and the faster the speed of the movement of the object of interest is, the greater the numerical value is.

8. The image processing apparatus according to claim 1, further comprising an output unit configured to output at least any one of the input image, the interaction map, and the state of the object.

9. The image processing apparatus according to claim 1,
wherein the object is a person, and
wherein the state is a state where, in a crowd composed of a plurality of persons, the person makes a motion different from a motion of another person near the person.

10. The image processing apparatus according to claim 9, wherein the state is at least any one of a backward move, an interruption, and a standstill of the person.

11. The image processing apparatus according to claim 1, further comprising:
an acquisition unit configured to acquire the interaction map for an image; and
a learning unit configured to learn, based on the acquired interaction map, the trained model that outputs an interaction map of an input image from the input image.

13. An image processing method executed by an image processing apparatus, the image processing method comprising:
acquiring, as an input image, time-series images obtained by capturing a plurality of objects;
acquiring an interaction map that indicates a difference between a first motion of a first object and a second motion of a second object at respective positions of each of the plurality of objects in the input image, by using the input image; and
detecting a state of the first motion present in the input image using the interaction map,
wherein the interaction map is estimated based on a trained model for estimating the interaction map and a parameter set prepared in advance.

14. A non-transitory computer-readable storage medium storing a program for causing a computer to execute an image processing method, the method comprising:
acquiring, as an input image, time-series images obtained by capturing a plurality of objects;
acquiring an interaction map that indicates a difference between a first motion of a first object and a second motion of a second object at respective positions of each of the plurality of objects in the input image, by using the input image; and
detecting a state of the first motion present in the input image by using the interaction map,
wherein the interaction map is estimated based on a trained model for estimating the interaction map and a parameter set prepared in advance.
